(19) United States
(12) Patent Application Publication
(10) Pub. No.: US 2003/0196081 A1
(43) Pub. Date: Oct. 16, 2003

(54) Methods, systems, and computer program products for processing a packet-object using multiple pipelined processing modules

(76) Inventors: Raymond Savarda, Apex, NC (US); David M. Blaker, Chapel Hill, NC (US); Dan Winkelstein, Raleigh, NC (US)

Correspondence Address: MYERS BIGEL SIBLEY & SAJOVEC, PO BOX 37428, RALEIGH, NC, 27627, US

(21) Appl. No.: 10/120,577

(22) Filed: Apr. 11, 2002

(51) Int. Cl. H04L 9/00

(52) U.S. Cl. 713/153; 713/200

(57) ABSTRACT

A packet is processed by encapsulating the packet with a packet-object header if the packet does not have a packet-object header. The encapsulated packet is processed based on information contained in the packet-object header using a plurality of transform modules that are coupled to each other in a series or pipeline configuration. The plurality of transform modules process the encapsulated packet independent of each other.

### BACKGROUND OF THE INVENTION

The present invention relates to packet processing methods, systems, and computer program products, and, more particularly, to methods, systems, and computer program products for processing packets in parallel.

The IP Security Protocol (IPSec) is a set of protocols developed by the Internet Engineering Task Force (IETF) to support the secure exchange of packets at the IP layer. IPSec has been widely used to implement virtual private networks (VPNs). IPSec supports two encryption modes: transport and tunnel. In transport mode only the data or payload portion of a packet is encrypted and the packet header is sent as clear text. In tunnel mode, both the packet header and the data/payload are encrypted. Sending and receiving devices use private keys to secure traffic therebetween. These keys along with security associations (SAs), which are unidirectional logical connections between two IPSec devices or systems, are negotiated by an Internet Key Exchange (IKE) function. An inbound SA may be uniquely identified by a Security Parameter Index (SPI), and IP destination address, and a security protocol. An outbound SA may be uniquely defined by a source IP address, a destination IP address, a protocol, a source port, and a destination port. To provide bi-directional communication, two SAs are typically defined, one in each direction.

IPSec systems manage SAs by maintaining two databases: a Security Policy Database (SPD) and a Security Association Database (SAD). The SPD specifies what security services are to be offered to the IP traffic. Typically, the SPD contains an ordered list of policy entries that are separate for inbound and outbound traffic. These policies may specify, for example, that some traffic must not go through IPSec processing, some traffic must be discarded, and some traffic must be IPSec processed.

The SAD contains parameter information about each SA. Such parameters may include the security protocol algorithms and keys for Authentication Header (AH) or Encapsulating Security Payload (ESP) security protocols, sequence numbers, protocol mode, and SA lifetime. For outbound packets, the SPD is consulted to determine if IPSec processing is required and/or if other processing or discarding of the packet is to be performed. If IPSec is required, then the outbound SAD is searched for an existing SA that matches the packet profile. If a SA is found or after negotiation of a SA, IPSec is applied to the packet as defined by the SA and the packet is delivered. For inbound packets, the inbound SAD can be directly consulted to determine if IPSec or other processing is required. If IPSec is required, then the SAD is searched for an existing security parameter index to match the security parameter index of the inbound packet. The SA is then used to process the packet by applying IPSec transforms to the inbound packet. A final check against inbound policy is made after inbound processing to verify the validity of the resulting packet.

Both IPSec processing and Secure Socket Layer (SSL) processing may, for example, require encryption and decryption of data as well as application of security policies to that data. Such security processing may adversely affect throughput of communications. For example, security processing may reduce the number of transactions an online banking system may receive in a given period of time. Similarly, throughput may be a concern in “real time” Internet applications, such as the transmission of video and/or audio. Provisioning of secure public VPNs for thousands of users may yield aggregate throughput requirements of many Gb/s. Emerging applications that also use IPSec for data confidentiality, like ISCSI, may have basic requirements of 1-10 Gb/s based on Gb ethernet connectivity. Thus, it may be beneficial to provide dedicated processing capabilities to perform the complex tasks associated with encryption, which may improve the performance of IPSec processing and, thereby, improve throughput.

IPSec transforms may be applied to IP packets in various ways. One approach is based primarily on software. For example, dedicated software modules may be developed for execution on a workstation to implement the IP packet manipulations, encryption, and authentication operations associated with the IPSec protocol. This approach, however, may be limited in its performance as the system processor performs many or all of the functions. Encryption, decryption, and/or authentication are typically processor intensive. Performance for primarily software-based systems may be limited to approximately 20-30 Mbits/second or less.

Another approach that has been used is to add a bus-based cryptographic chip that communicates with the system processor to implement the IPSec protocol. The software running on the system processor may still be responsible for IPSec policy lookup, SA management, fragmentation, de-fragmentation, and header construction. The cryptographic chip may perform the encryption, decryption, and/or authentication transforms as required. After completion of the cryptographic operations, the system processor may further process the packet to finish any remaining IPSec transforms. Although these systems may provide improved performance over primarily software based systems, performance may still be limited due to the transform responsibilities still remaining with the system processor and/or the throughput limitations of the communication bus between the system processor and the cryptographic chip, and the multiple copies of the packet that may be required between the host processor memory and the cryptographic chip.

Yet another approach that has been used is to dedicate multiple processors to implement the IPSec protocol with each processor having its own set of one or more cryptographic chips on a private bus. This architecture may be viewed as an array of smaller IPSec subsystems that are controlled by an overall system processor that schedules the distribution of packets to and the collection of packets from the various subsystems. Unfortunately, such an architecture may use up valuable board space, increase the cost of the system, and increase power consumption due to the many embedded processors. The system processor may also be burdened with additional overhead in allocating packets to the IPSec subsystems and, potentially, managing multiple databases (e.g., SA databases) associated with each subsystem. Overall latency may be no better than the latency of the worst performing IPSec subsystem.

### SUMMARY OF THE INVENTION

According to some embodiments of the present invention, a packet is processed by encapsulating the packet with a packet-object header if the packet does not have a packet-object header. The encapsulated packet is processed based on information contained in the packet-object header using a plurality of transform modules that are coupled to each other in a series configuration. The plurality of transform modules process the encapsulated packet independent of each other. Thus, some embodiments of the invention may facilitate processing of both inbound and outbound packet-objects in a common pipeline, which may provide parallelism in the sequential operations performed on the packets to implement packet transformations required by standard security protocols, such as IPSec or SSL.

### BRIEF DESCRIPTION OF THE DRAWINGS

Other features of the present invention will be more readily understood from the following detailed description of specific embodiments thereof when read in conjunction with the accompanying drawings, in which:

FIG. 1 illustrates a packet co-processor pipeline architecture in accordance with some embodiments of the present invention;

FIG. 2 illustrates a packet-object header structure in accordance with some embodiments of the present invention;

FIG. 3 illustrates a pipeline processing header for an outbound packet-object in accordance with some embodiments of the present invention;

FIG. 4 illustrates a pipeline processing header for an inbound packet-object in accordance with some embodiments of the present invention;

FIG. 5 is a flowchart that illustrates exemplary operations for processing a packet using multiple pipelined processing modules in accordance with some embodiments of the present invention; and

FIG. 6 is a block diagram that illustrates a cryptographic transform module that may be used in the packet co-processor pipeline architecture of FIG. 1 in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

Embodiments of the present invention are described herein in the context of processing a packet. It will be understood that the term “packet” means a unit of information that may be transmitted electronically as a whole from one device to another. Accordingly, as used herein, the term “packet” may encompass such terms of art as “frame” or “message,” which may also be used to refer to a unit of transmission.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

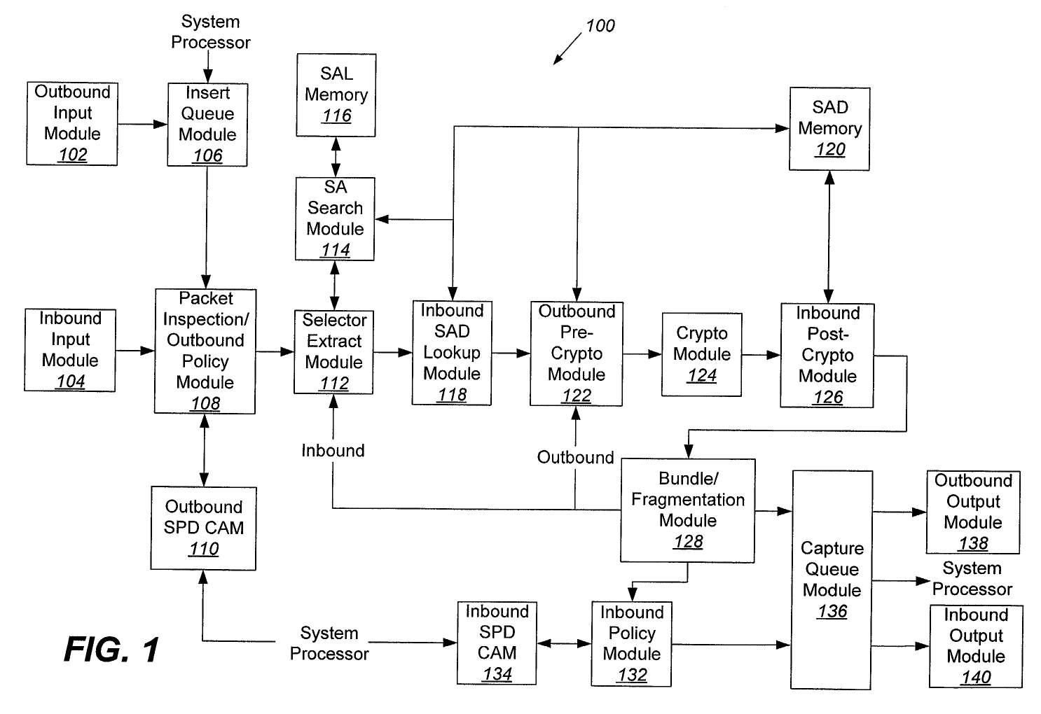

Referring now to FIG. 1, a packet co-processor 100 is illustrated that may communicate with a system processor to implement, for example, the IPSec protocol, in accordance with some embodiments of the present invention. In particular, the packet co-processor 100 may be dedicated to performing the packet transforms and cryptographic operations associated with the IPSec protocol. As shown in FIG. 1, the packet co-processor 100 comprises a plurality of transform modules that are coupled to each other in a series configuration.

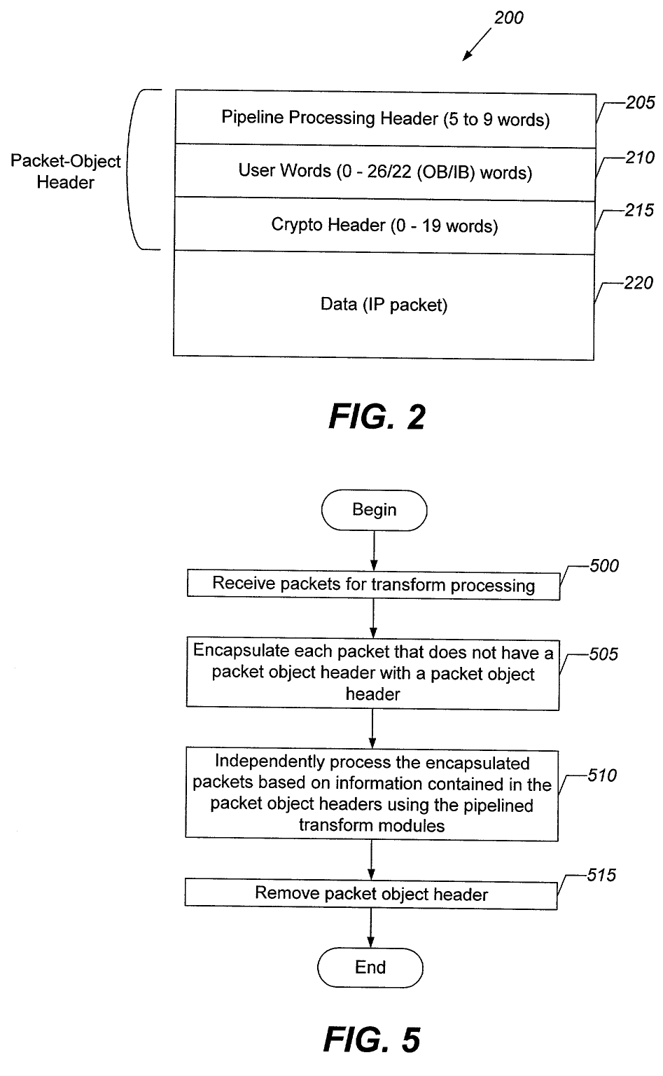

In some embodiments of the present invention, parallel processing may be furthered through the encapsulation of an IP packet with its associated context information. Such an encapsulation is illustrated in FIG. 2 with respect to an encapsulated IP packet, which may be called a packet-object 200. The packet-object 200 includes a packet-object header, which comprises a pipeline processing header 205, user words 210, a crypto header 215, and data 220. Packet-objects 200 may traverse the pipelined transform modules of the packet co-processor 100 of FIG. 1, which may provide parallelism in the sequential operations performed on the core IP packets to implement packet transformations required by standard security protocols, such as IPSec or SSL.

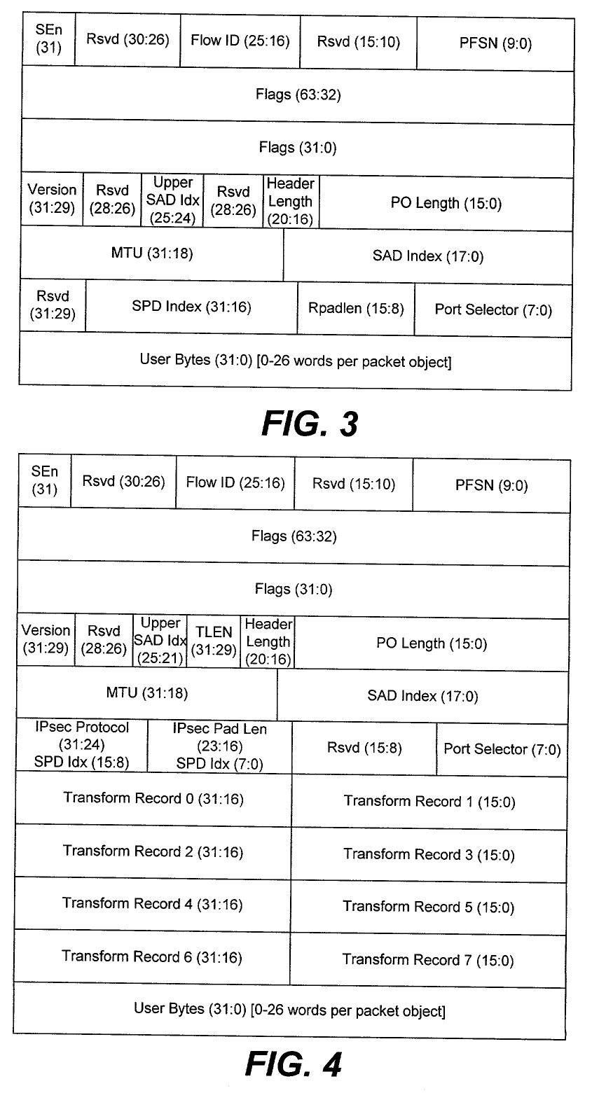

In more detail, the pipeline processing header 205 comprises action, routing, error, and informational fields and is the first portion of the packet-object that is available at each transform module in the packet co-processor 100 pipeline. This may allow fast determination of the correct processing to perform while the rest of the packet is being received at the respective transform module. FIGS. 3 and 4 illustrate exemplary pipeline processing header 205 formats for outbound and inbound packet-objects, respectively. The user words 210 field is an optional field that may be used to carry information transparently through the packet co-processor 100 pipeline. The crypto header 215 field may comprise the cryptographic (crypto) information used by the crypto transform module in the packet co-processor 100 pipeline to perform encryption, decryption, and/or authentication transforms on the IP packets carried in packet-objects. The data 220 may comprise a formatted IP packet, which may include, but is not limited to, an authentication header (AH), an encapsulating security payload (ESP), AH authentication data, ESP authentication data, and a UDP or TCP payload.

Referring now to FIG. 5, exemplary operations of the packet co-processor 100 pipeline may be broadly described as receiving packets for transform processing (block 500), encapsulating each of the packets that does not have a packet-object header with a packet-object header (block 505), and independently processing the encapsulated packets based on information contained in the packet-object headers using a plurality of transform modules that are coupled to each other in a series or pipeline configuration (block 510). The packet object-object header may then be removed for further processing of the encapsulated packet (block 515).

Returning to FIG. 1, the packet co-processor 100 transform modules and exemplary operations thereof, in accordance with some embodiments of the present invention, will now be described in detail. The packet co-processor 100 may be configured to process both outbound and inbound packet streams. An outbound input module 102 may be configured to receive an outbound packet stream and an inbound input module 104 may be configured to receive an inbound packet stream. Both the outbound input module 102 and the inbound input module 104 may be configured to perform the low-level interface protocol adaptation between, for example, a framer and the packet co-processor 100.

The outbound and inbound input modules 102 and 104 may be further configured to add a packet-object header (see FIGS. 2, 3, and 4) to the packet to create a packet-object if the packet does not have a packet-object header, to determine how the packet should be routed through the packet co-processor 100, and to update the flags and packet-object length (PO length) in the pipeline processing header 205. A packet-object may be routed in three different ways as follows: 1) the packet-object may be routed through the packet co-processor 100 as an IP packet with all appropriate IPSec transforms applied thereto; 2) the packet-object may be captured to the system control processor, and 3) the packet-object may be passed through the packet co-processor 100 as a non-IP packet without any IP processing or IPSec transforms applied. Flags may be set in the pipeline processing header 205 to indicate how the packet is to be routed through the packet co-processor 100. Note that the outbound and inbound input modules 102 and 104 may also discard or reject a packet-object, if, for example, the packet contains errors, is improperly formatted, or is associated with a non-supported protocol.

The insert queue module 106 is coupled to the system processor over a communication bus and may be configured with a FIFO memory and multiplexing circuitry to allow the system processor to insert inbound and/or outbound packets into the processing pipeline even in the case of a continuous packet stream input to the processing pipeline.

The packet inspection/outbound policy module 108 may be configured with multiplexing circuitry to integrate the outbound and inbound packet streams into a single stream for pipeline processing in the packet co-processor 100. In addition, the packet inspection/outbound policy module 108 may be further configured to inspect packet-objects to ensure their integrity. For example, routing flags in the pipeline processing header 205 may be checked to determine if the packet-object should be captured by the control processor, passed through the packet co-processor 100 as a non-IP packet, or discarded. If the routing flags indicate that the packet-object is to be captured, passed through, or discarded, then the packet-object will not be processed by any subsequent transform modules in the packet co-processor 100. Additional checks may be performed on the packet-object, such as, but not limited to, verifying that the packet-object length is greater than or equal to a minimum length (e.g., the minimum size of a packet-object header is 20 bytes and the minimum size of a packet-object carrying an IP packet is 40 bytes), verifying that the data field 220 is greater than or equal to a minimum length (e.g., 20 bytes for an IP packet), verifying that the IP header checksum is correct, verifying that the IP version number is correct, verifying that the IP header length field is ≧20 bytes (five 32-bit words), verifying that the IP length field (bytes) is 4*IP header length field, and/or verifying that the IP length field is correct.

If any of the foregoing checks finds an error, then an error flag is set in the pipeline processing header 205 and the packet-object is not operated on by any subsequent transform modules in the packet co-processor. Instead, the packet-object is placed in the capture buffer of either the outbound output module 138 or the inbound output module 140 for error handling by the system processor.

The packet inspection/outbound policy module 108 may be further configured to determine if an outbound packet-object has a policy associated therewith. Specifically, the packet inspection/outbound policy module 108 may extract selectors from the outermost IP header of an outbound packet-object and use these selectors to perform a security policy lookup in the outbound SPD content addressable memory (CAM) 110. In accordance with some embodiments of the present invention, the selectors may comprise a source IP address, a destination IP address, a protocol, a source TCP/UDP port, a destination TCP/UDP port, and an interface port (i.e., the port selector field in the pipeline processing header, which is inserted by either the outbound input module 102 or the inbound input module 104). In some embodiments of the present invention, the protocol used for SPD and SA lookup must be a transport protocol. Therefore, if the protocol is determined to be IP in IP (encapsulation), AH (authentication header for IP Version 6), IP Mobility, or IPComp (IP Payload Compression Protocol), then the packet inspection/outbound policy module 108 parses down to the next inner IP header to analyze that header, recursively, until the transport protocol is obtained in accordance with the IPSec specification. In some embodiments, the IP headers will be parsed down through four levels. If a transport protocol is not found within four levels, then a no transport protocol error flag and a capture routing flag may be set in the pipeline processing header 205 to direct the packet-object to the system processor for error handling.

If a policy is found in the outbound SPD CAM 110, then the policy index (i.e., SPD index) and the capture, discard, pass through, IKE, and control port flags are copied into the pipeline processing header 205. If a policy is not found, then a no security policy match flag along with a capture flag is set in the pipeline processing header 205 to inform the control processor that the present packet-object is non-compliant. The SPD CAM 110 may be populated by the system processor based on security policies defined by a system operator or via an automated policy manager that can communicate with the system processor.

For inbound packet-objects, the packet inspection/outbound policy module 108 may be configured to determine if the packet-object is to be subject to IPSec transforms by examining the IP header protocol field. If the IP header protocol field is ESP or AH, then the destination IP address is compared with valid destination IP addresses stored, for example, in a binary CAM. If the inbound packet-object is not ESP or AH or the destination IP address is invalid, then a routing flag is updated in the pipeline processing header 205 to mark this packet-object for pass through treatment to the inbound policy module 132 where it may be passed through to the inbound output module 140 or discarded.

The selector extract module 112 may be configured to extract selectors from a packet-object and to pass these selectors along with the SPD index (see FIGS. 3 and 4) from the pipeline processing header 205 to the SA search module 114 to obtain an SAD index. While the SA search module 114 is attempting to obtain the SAD index from the SA Lookup (SAL) memory 116, the selector extract module 112 may complete the reading in of the packet-object. Once the SAD index is obtained, the selector extract module 112 may release the packet-object to the inbound SAD lookup module 118 while simultaneously receiving another packet-object at its input port.

In more detail, for outbound packet-objects, the selector extract module 112 may be configured to extract the same selectors as are extracted by the packet inspection/outbound policy module 108 for obtaining the policy index from the outbound SPD CAM 110. Those selectors, along with the policy index, are passed to the SA search module 114 for obtaining the SAD index from the SAL memory 116. For inbound packet-objects, if the IP header protocol field is not ESP or AH (i.e., the packet-object is not subject to IPSec transforms) or if the capture, pass through or discard flags are set in the pipeline processing header 205, then the packet-object is not processed by the selector extract module 112. Otherwise, selectors are extracted from the inbound packet-object and these selectors are passed to the SA search module 114 for obtaining the SAD index from the SAL memory 116. In accordance with some embodiments of the present invention, the selectors for the inbound packet-object may comprise a destination IP address, a protocol, a SPI (from IP packet, ESP, or AH header), and an interface port (i.e., the port selector field in the pipeline processing header, which is inserted by the inbound input module 104).

The SA search module 114 accepts the selectors and policy index from the selector extract module 112 and looks up the SAD index in the SAL memory 116. The SA search module 114 returns either the SAD index or an indication of invalid security policy or security association not found. If a SAD index is not returned, then the selector extract module 112 may set a SA lookup error flag in the pipeline processing header 205.

In some embodiments of the present invention, the policy index may be used to retrieve an SA mask record from an SA mask table in the SAL memory 116. This mask may be ANDed with the selectors for an outbound packet-object before the selectors are used to generate a hash value for obtaining the SAD index. The SA search module 114 may be configured to implement a hash-based search method to obtain the SAD index from the SAL memory 116. In particular embodiments, the SA search module generates a hash value to derive a starting location within a table (database) in the SAL memory. A linear search is then used to find an SA record that matches the packet-object. The hash values may be calculated as follows:

Inbound hash value=(SPI*383+Dest*257+Prot*7919+Intf*6143) %M

Outbound hash value=(Src*383+Dest*257+Prot*7919+Src_port*2017+Dest_port*1031+Intf*6143) %M

The value M=2²³−15=8388593. The hash values are reduced to the maximum number of SAs supported by the packet co-processor 100. Exemplary linear search operations of the SAL memory 116 are described in U.S. patent application Ser. No. 09/845,432, entitled Hash-Ordered Databases and Methods, Systems and Computer Program Products for Use of a Hash-Ordered Database, the disclosure of which is hereby incorporated herein by reference.

Each entry in the SA lookup database may comprise a policy number, a masked transport protocol, a masked source IP address, a masked destination IP address, a masked source TCP/UDP port, and a masked destination TCP/UDP port. Associated with each SA lookup entry is a hash key/SA index field. This data may be physically stored at a location that is equal to the address at which the hashed selectors matched divided by two. The hash key/SA index field may comprise an allow fragment flag, a hash key value, and the SA index for the SAD database. The hash key value corresponds to the hash value generated from the selectors. The SA index is the pointer to the location of the keys, outer IP header, lifetime counts, and other information in the SAD database associated with this SA.

The inbound SAD lookup module 118 may be configured to use the SAD index obtained by the SA search module 114 to obtain the SAD record in the SAD memory that corresponds to the SAD index. The cryptographic information from the SAD record may be stored in the crypto header 215 of the packet-object. This cryptographic information may include sequencing information that is used during cryptographic processing. In some embodiments, the inbound SAD lookup module 118 may determine whether packet fragments are received and whether defragmentation will be applied based on flags set in the pipeline processing header 205. If the IPSec protocol field or the IPSec mode flag in the pipeline processing header 205 is not ESP or AH (i.e., the packet-object is not subject to IPSec transforms) or if the capture, pass through or discard flags are set in the pipeline processing header 205, then the packet-object is not processed by the inbound SAD lookup module 118.

The outbound pre-crypto module 122 may be configured to handle time-to-live (TTL) decrement operations, pre-cryptographic fragmentation, and insertion of IPSec information into the crypto header 215. In more detail, the outbound pre-crypto module 122 may check a forwarded flag in the pipeline processing header 205 to determine whether a packet-object originates with the present gateway or has been forwarded from another gateway. If the packet-object has been forwarded, then the TTL value in the IP header is decremented. If the TTL value is 0 or −1, then the capture flag and TTL zero error flags are set in the pipeline processing header 205 so that the system processor is instructed to capture the packet-object for further processing.

The outbound pre-crypto module 122 may be further configured to handle pre-cryptographic fragmentation of an outbound packet-object. To determine how to fragment a packet-object, the outbound pre-crypto module 122 obtains the maximum transmission unit (MTU) size, mode (transport/tunnel), and protocol type (ESP/AH) from the SAD database in the SAD memory 120. The proper offset may be derived by adding a fixed value to the SAD index. The MTU field in the pipeline processing header 205 is updated based on the MTU size read from the SAD database. Based on the foregoing information obtained from the SAD database, the outbound pre-crypto module 122 may fragment the packet-object into chunks before additional IPSec headers are added to the packet-object. Packet-objects associated with a tunnel mode IPSec packet may be fragmented prior to encryption. If the SA is associated with transport mode, clear text, or a policy that requires TCP/UDP port numbers, then the allow fragment flag in the pipeline processing header 205 is cleared to prevent pre-encryption fragmentation. If the SA is associated with a SA bundle, then the allow fragment flag only applies to the first SA in the bundle. Fragmentation results in multiple new packet-objects, in accordance with some embodiments of the present invention, with a per-fragment size set by the MTU field in the pipeline processing header 205.

The outbound pre-crypto module 122 may be further configured to insert the IPSec header information into the outbound packet-object. In particular, the SAD database in the SAD memory 120 contains the actual information about how to process the packet-object. The outbound pre-crypto module 122 may obtain the keys (encryption and authentication), sequence number, and outer IP header (for tunnel mode) from the SAD database. This information may be formatted in various ways, in accordance with some embodiments of the present invention, such as ESP tunnel mode, AH tunnel mode, clear text, ESP transport mode, AH transport mode, and IPCOMP. The cryptographic information may be stored in the crypto header 215 of the packet-object. The outer IP header for tunnel mode may be inserted before the original IP header. The remaining information obtained from the SAD database may be stored in various fields in the packet-object. The sequence number, initial vector, byte lifetimes, packet count, and user data count may be updated in the SAD database. A determination may also be made whether the packet-object has exceeded the byte or time lifetimes. Padding may be added to the end of ESP packets. When using ESP encryption, the initial vector may be calculated using a 64-bit linear feedback shift register with a polynomial of x⁶⁴+x⁴+x³+x+1. Each time a packet-object is processed, the initial vector is included in the packet-object header.

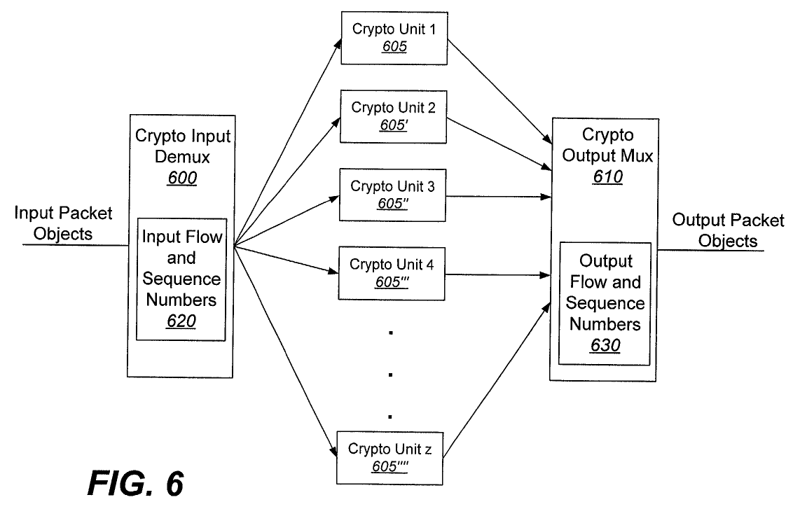

FIG. 6 illustrates some embodiments of the crypto module 124 in accordance with the present invention. A packet-input demultiplexer (demux), illustrated as the crypto-demux 600, receives an input stream of cryptographic packets. The input stream of cryptographic packets may be outbound and/or inbound packet-objects. The demux 600 receives the serial stream of packet-objects and multiplexes them to a plurality of cryptographic processing units (crypto-units) 605, 605′, 605″, 605′″, and 605″″. The crypto-units 605, 605′, 605″, 605′″, and 605″″ may be any form of cryptographic processor capable of carrying out the operations described herein and may be all the same or may differ. For example, the crypto-units 605, 605′, 605″, 605′″, and 605″″ illustrated in FIG. 6 may have differing processing capabilities, may have differing processing speeds, and/or may be multiple processors of the same type. In particular embodiments of t he present invention, the crypto-units 605, 605′, 605″, 605′″, and 605″″ may support 3DES, AES, SHA-1, and/or MD5 cryptographic processing. Furthermore, while FIG. 6 illustrates cryptographic processing embodiments of the present invention, other packet transformation operations may also be performed in such a parallel system. Thus, the crypto-units 605, 605′, 605″, 605′″, and 605″″ illustrated in FIG. 6 may be replaced by other packet transform processors, such as compression processors or the like, which may be utilized in particular embodiments of the present invention.

The crypto-input demux 600 may provide the packet-objects to the crypto-units 605, 605′, 605″, 605′″, and 605″″ on a round-robin basis, based on the processing characteristic of a particular one of the crypto-units 605, 605′, 605″, 605′″, and 605″″ to balance workload or based on other criteria for distribution of packets to the crypto-units 605, 605′, 605″, 605′″, and 605″″. After processing, the crypto-units 605, 605′, 605″, 605′″, and 605″″ provide the processed packet-objects to the packet-output multiplexer (mux), illustrated as the crypto-output mux 610. The crypto-output mux 610 re-orders the packet-objects from the crypto-units 605, 605′, 605″, 605′″, and 605″″ so as to provide output packet-objects in a serial stream.

The crypto-input demux 600 also assigns a sequence identifier and maintains an identification of a current sequence identifier to assign to a next received packet-object. In particular embodiments of the present invention, sequence identifiers are assigned to related packets so as to define an order of the related packets. In some embodiments illustrated in FIG. 1, the related packets are identified as a “flow” such that an input flow identifier and a sequence number are associated with each received packet and the current sequence number for a given flow is maintained in the input flow and sequence number table 620. As described above, input packet-objects may be characterized as either an inbound or outbound packet. Similarly, flows of inbound packets may be referred to as inbound flows and flows of outbound packets may be referred to as outbound flows.

The crypto-output mux 610 receives the processed packets from the crypto-units 605, 605′, 605″, 605′″, and 605″″ based on the sequence identifier of the processed packet-object. For embodiments of the present invention using a flow identifier, which is stored in the pipeline processing header 605, as between packets from different flows, the crypto-output mux 610 may accept packet-objects for output based on a round-robin distribution scheme, based on a fairness scheme, or based on crypto history so as to ensure that packets are not “stuck” in the crypto-units 605, 605′, 605″, 605′″, and 605″″. By accepting for output the packet-objects in a sequence identifier order, the crypto-output mux 610 outputs the packets in sequence order and, thus, parallel processing of the packets may be accomplished while maintaining the sequence of the packets so that they do not require re-ordering.

The crypto-output mux 610 maintains a next sequence identifier in the sequence to compare the stored next sequence identifier with a sequence identifier of a processed packet-object to determine if the processed packet-object is the next packet in the sequence of packet-objects. In particular embodiments of the present invention where sequence identifiers are assigned to related packet-objects to define an order of the related packet-objects, a sequence identifier is defined for each of the different related packet-objects. In some embodiments illustrated in FIG. 6, the related packet-objects are identified as a flow such that a flow identifier and a sequence number are associated with each received packet-object in the packet-object header. In such embodiments, the crypto-output mux 610 maintains the next sequence number for a given flow in the output flow and sequence number table 630.

Exemplary operations of the crypto module 124 are described in U.S. patent application Ser. No. 09/999,647, entitled Methods, Systems And Computer Program Products For Packet Ordering For Parallel Cryptographic Processing, the disclosure of which is hereby incorporated herein by reference.

The inbound post-crypto module 126 may be configured to inspect inbound packet-objects to ensure their integrity. For example, routing flags in the pipeline processing header 205 maybe checked to determine if the packet-object should be captured by the control processor, passed through the packet co-processor 100 as a non-IP packet, or discarded. If the routing flags indicate that the packet-object is to be captured, passed through, or discarded, then the packet-object will not be processed by any subsequent transform modules in the packet co-processor 100. Additional checks maybe performed on the packet-object, such as, but not limited to, verifying that the packet-object length is greater than or equal to a minimum length (e.g., the minimum size of a packet-object header is 20 bytes and the minimum size of an IP packet is 40 bytes), verifying that the data field 220 is greater than or equal to a minimum length (e.g., 20 bytes for an IP packet), verifying that the IP header checksum is correct, verifying that the IP version number is correct, verifying that the IP header length field is 20 bytes (five 32-bit words), verifying that the IP length field (bytes) is 4*IP header length field, and/or verifying that the IP length field is correct.

If any of the foregoing checks finds an error, then an error flag is set in the pipeline processing header 205 and the packet-object is not operated on by any subsequent transform modules in the packet co-processor. Instead, the packet-object is placed in the capture buffer for error handling by the system processor.

In addition, the inbound post-crypto module 126 may validate the SA selector fields with those stored in the SAD database in the SAD memory 120 and may update other SA-specific state information such as byte lifetimes, packet count, and user data count.

The bundle/fragmentation module 128 may be configured to check for SA bundles in outbound packet-objects by readings a more bundles flag in the pipeline processing header 205. If the flag is set, then the packet-object is routed to the outbound pre-crypto module 122 for further processing. In accordance with particular embodiments, the SA entries for a bundle are adjacent in the SAD database in the SAD memory 120. This may allow the next SA in the bundle to be accessed by incrementing the SAD index field in the pipeline processing header 205. For inbound packet-objects, if no errors have been flagged, then the IPSec headers and any ESP padding that may have been applied may be stripped from the packet-object. The layered IP headers will be analyzed and removed until a transport protocol header or an IP destination address that is not for the current system is encountered. The inbound packet-object is then routed to the selector extract module 112 to process the next SA. The bundle/fragmentation module 128 may be further configured to fragment outgoing IPSec packet-objects if they are larger than the allowed path MTU between the IPSec and fragmentation is allowed as represented by a flag in the outermost IP header. The bundle/fragmentation module may be further configured to decrement the TTL value in the IP header. If the TTL value is 0 or −1, then the capture flag and TTL zero error flags are set in the pipeline processing header 205 so that the system processor is instructed to capture the packet-object for further processing.

Inbound packet-objects are routed to the inbound policy module 132 from the bundle/fragmentation module 128. The inbound policy module 132 may be configured to determine if an inbound packet-object has a policy associated therewith. Specifically, the packet inbound policy module 132 may extract selectors from the outermost IP header of an inbound packet-object and use these selectors to perform a security policy lookup in the inbound SPD content addressable memory (CAM) 134. In accordance with some embodiments of the present invention, the selectors may comprise a source IP address, a destination IP address, a protocol, a source TCP/UDP port, a destination TCP/UDP port, and an interface port (i.e., the port selector field in the pipeline processing header, which is inserted by either the outbound input module 102 or the inbound input module 104). In some embodiments of the present invention, the protocol used for SPD and SA lookup must be the transport protocol. Therefore, if the protocol is determined to be IP in IP (encapsulation), AH (authentication header for IP Version 6), IP Mobility, or IPComp (IP Payload Compression Protocol), then the inbound policy module 132 parses down to the next inner IP header to analyze that header, recursively, until the transport protocol is obtained in accordance with the IPSec specification. In some embodiments, the IP headers will be parsed down through four levels. If a transport protocol is not found within four levels, then a no transport protocol error flag and a capture routing flag may be set in the pipeline processing header 205 to direct the packet-object to the system processor for error handling.

If a policy is found in the inbound SPD CAM 134, then the policy index (i.e., SPD index) and the capture, discard, pass through, IKE, and control port flags are copied into the pipeline processing header 205. If a policy is not found, then a no security policy match flag along with a capture flag is set in the pipeline processing header 205 to inform the control processor that the present packet-object is non-compliant. The SPD CAM 134 may be populated by the system processor based on security policies defined by a system operator or via an automated policy manager that can communicate with the system processor.

Outbound packet-objects from the bundle/fragmentation module 128 and inbound packet-objects from the inbound policy module 132 are provided to the capture queue module 136. The capture queue module 136 may be configured to examine the routing flags in the pipeline processing header 205 to determine if the system processor should capture this packet-object or obtain a copy of this packet-object. If the packet-object is to be captured by the system processor, then the capture queue module 136 stores the packet-object into one of several defined queues. In some embodiments of the present invention, the system processor may access packet-objects in the queues using direct memory access (DMA).

An outbound output module 138 may be configured to receive an outbound packet stream and an inbound output module 140 may be configured to receive an inbound packet stream from the capture queue module 136. Both the outbound output module 138 and the inbound input module 140 may be configured to perform the low-level interface protocol adaptation between the packet co-processor 100 and, for example, an output bus, either streaming or bus-based.

Thus, as discussed above, some embodiments of the packet co-processor 100, according to the present invention, may facilitate processing of both inbound and outbound packet-objects in a common pipeline. In particular embodiments, the transform modules comprising the packet co-processor 100 may be configured with transform responsibilities that consume similar amounts of real-time to allow packets to move from transform module to transform module in a pipelined fashion. In other embodiments of the present invention, separate pipelines may be defined for the inbound and outbound packet-object streams. Such embodiments may allow for the elimination of some multiplexing and demultiplexing circuitry, but may use multiple transform modules to perform transform operations that are common to both inbound packet-objects and outbound packet-objects. In addition, these embodiments may provide higher performance.

Although FIG. 1 illustrates an exemplary packet co-processor 100 architecture, it will be understood that the present invention is not limited to such a configuration, but is intended to encompass any configuration capable of carrying out the operations described above. In general, to enhance throughput, the packet co-processor 100 transform modules may be respectively implemented as one or more application specific integrated circuits (ASICs). In addition, the entire packet co-processor 100 may be implemented as one or more (ASICs). It will be further appreciated, however, that the functionality of any or all of the packet co-processor 100 transform modules may be implemented using one or more ASICs, discrete hardware components, a programmed digital signal processor or microcontroller, and/or combinations thereof. In this regard, computer program code for carrying out operations of the respective packet co-processor 100 transform modules discussed above may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The flowchart of FIG. 5 illustrates the architecture, functionality, and operations of some embodiments of the packet co-processor 100. In this regard, each block represents a module, segment, or portion of code, which comprises one or more executable instructions for implementing the specified logical function(s). It should also be noted that in other implementations, the function(s) noted in the blocks may occur out of the order noted in FIG. 5. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

We claim:

1. A method of processing a packet, comprising:
encapsulating the packet with a packet-object header if the packet-object does not have a packet-object header; and
processing the encapsulated packet based on information contained in the packet-object header using a plurality of transform modules that are coupled to each other in a series configuration, respective ones of the plurality of transform modules processing the encapsulated packet independent of other ones of the plurality of transform modules.

2. A method of processing packets, comprising:
receiving the packets;
encapsulating each of the packets that does not have a packet-object header with a packet-object header; and
processing the encapsulated packets based on information contained in the packet-object headers using a plurality of transform modules that are coupled to each other in a series configuration, respective ones of the plurality of transform modules processing the encapsulated packets in parallel independent of other ones of the plurality of transform modules.

3. The method of claim 2, wherein one of the plurality of transform modules comprises a plurality of parallel processors, the method further comprising:
assigning a sequence identifier to each of the packets that specifies a serial order associated with the packet;
providing the packets to the plurality of parallel processors;
processing the packets in parallel using the plurality of parallel processors; and
ordering the processed packets at an output of the one of the plurality of transform modules based on the sequence identifiers assigned to the packets.

4. The method of claim 3, further comprising:
classifying the packets so as to identify related packets;
wherein assigning the sequence identifier comprises assigning the sequence identifier to related packets that specifies an ordering of the related packets; and
wherein ordering the processed packets comprises ordering the processed packets at the output of the one of the plurality of transform modules based on the classifications of the packets and the sequence identifiers assigned to the packets.

5. The method of claim 4, further comprising:
assigning a flow identifier to related packets based on the classifications of the packets.

6. The method of claim 5, wherein classifying the packets comprises evaluating a source address, destination address, and a protocol associated with the packets; and
wherein assigning the flow identifier comprises assigning a flow identifier to related packets based on the source address, destination address, and protocol associated with the packets.

7. The method of claim 5, wherein classifying the packets comprises evaluating a destination address, a security parameter index, and a protocol associated with the packets; and
wherein assigning the flow identifier comprises assigning a flow identifier to related packets based on the destination address, security parameter index, and protocol associated with the packets.

8. The method of claim 2, wherein the packets comprise cryptographic packets.

9. The method of claim 2, wherein the packets comprise a first plurality of packets associated with an inbound packet stream and a second plurality of packets associated with an outbound packet stream.

10. The method of claim 9, wherein processing the encapsulated packets comprises processing the first plurality of packets associated with the inbound packet stream and the second plurality of packets associated with the outbound packet stream using at least one of the plurality of transform modules.

11. The method of claim 2, further comprising:
updating routing flags in a respective one of the packet-object headers to indicate whether a respective one of the packet-objects should be processed by the plurality of transform modules, passed through the plurality of transform modules without being transformed, or captured by a system processor.

12. The method of claim 2, further comprising:
multiplexing an inbound stream of encapsulated packets with an outbound stream of encapsulated packets into a serial stream of encapsulated packets.

13. The method of claim 12, further comprising:
verifying that a respective one of the encapsulated packets has fields that are populated with data that are within specified limits.

14. The method of claim 12, further comprising:
extracting selectors from a respective one of the outbound encapsulated packets; and
obtaining a security policy index from a security policy database for the respective one of the outbound encapsulated packets based on the extracted selectors.

15. The method of claim 14, wherein the selectors comprise a source IP address, a destination IP address, a protocol, a source port, and a destination port.

16. The method of claim 15, wherein the protocol is a transport protocol.

17. The method of claim 14, further comprising:
searching a security association database to obtain a security association for the respective one of the outbound encapsulated packets based on the extracted selectors and the security policy index.

18. The method of claim 17, wherein searching the security association database comprises:
hashing the extracted selectors and the security policy index to obtain a hash key value; and
performing a linear search in the security association database using the hash key value.

19. The method of claim 17, further comprising:
inserting cryptographic information into the packet-object header of the respective one of the outbound encapsulated packets based on the security association for the respective one of the outbound encapsulated packets.

20. The method of claim 12, further comprising:
extracting selectors from a respective one of the inbound encapsulated packets.

21. The method of claim 20, wherein the selectors comprise a destination IP address, a protocol, a security policy index, and an interface port.

22. The method of claim 21, wherein the protocol is a transport protocol.

23. The method of claim 20, further comprising:
searching a security association database to obtain a security association for the respective one of the inbound encapsulated packets based on the extracted selectors.

24. The method of claim 23, wherein searching the security association database comprises:
hashing the extracted selectors to obtain a hash key value; and
performing a linear search in the security association database using the hash key value.

25. The method of claim 23, further comprising:
inserting cryptographic information into the packet-object header of the respective one of the inbound encapsulated packets based on the security association for the respective one of the inbound encapsulated packets.

26. The method of claim 12, further comprising:
decrypting a respective one of the inbound encapsulated packets; and
verifying that the respective one of the inbound encapsulated packets has fields that are populated with data that are within specified limits.

27. The method of claim 12, further comprising:
fragmenting a respective one of the encapsulated packets if a size of the respective one of the encapsulated packets exceeds a maximum transmission unit size associated with the respective one of the encapsulated packets.

28. The method of claim 12, further comprising:
decrypting a respective one of the inbound encapsulated packets;
extracting selectors from the respective one of the inbound encapsulated packets; and
obtaining a security policy index from a security policy database for the respective one of the inbound encapsulated packets based on the extracted selectors.

29. The method of claim 28, wherein the selectors comprise a source IP address, a destination IP address, a protocol, a source port, a destination port, and an interface port.

30. The method of claim 29, wherein the protocol is a transport protocol.

31. The method of claim 11, further comprising:
capturing a respective one of the encapsulated packets to a system processor based on at least one of the routing flags.

32. A method of processing packets, comprising:
receiving the packets;
encapsulating each of the packets that does not have a packet-object header with a packet-object header; and
processing the encapsulated packets based on information contained in the packet-object headers in parallel in a pipelined processing system, respective ones of the encapsulated packets being processed independent of other ones of the encapsulated packets.

33. A packet processing system, comprising:
a plurality of transform modules that are coupled to each other in a series configuration and are configured to receive a serial stream of packets that are each encapsulated with a packet-object header, respective ones of the plurality of transform modules being further configured to process the encapsulated packets in parallel independent of other ones of the plurality of transform modules based on information contained in the packet-object headers.

34. The packet processing system of claim 33, wherein one of the plurality of transform modules comprises:
a plurality of parallel processors;
a demultiplexer that is configured to receive the serial stream of packets, identify a sequence of the received packets, and provide the packets to the plurality of parallel processors; and
a multiplexer that is configured to receive processed packets from the plurality of parallel processors and to output the processed packets in the sequence identified by the demultiplexer.

35. The packet processing system of claim 34, wherein the demultiplexer is further configured to assign a sequence identifier to related packets that specifies an ordering of the related packets; and
wherein the multiplexer is further configured to order the processed packets based on the sequence identifiers assigned to the packets.

36. The packet processing system of claim 34, wherein the demultiplexer is further configured to classify the packets so as to identify related packets and to assign a flow identifier to related packets based on the classifications of the packets.

37. The packet processing system of claim 36, wherein the demultiplexer is further configured to evaluate a source address, destination address, and a protocol associated with the packets and assign a flow identifier to related packets based on the source address, destination address, and protocol associated with the packets.

38. The packet processing system of claim 36, wherein the demultiplexer is further configured to evaluate a destination address, a security parameter index, and a protocol associated with the packets and assign a flow identifier to related packets based on the destination address, security parameter index, and protocol associated with the packets.

39. A system for processing packets, comprising:
means for receiving the packets;
means for encapsulating each of the packets that does not have a packet-object header with a packet-object header; and
means for processing the encapsulated packets based on information contained in the packet-object headers using a plurality of transform modules that are coupled to each other in a series configuration, respective ones of the plurality of transform modules processing the encapsulated packets in parallel independent of other ones of the plurality of transform modules.

40. The system of claim 39, wherein one of the plurality of transform modules comprises a plurality of parallel processors, the system further comprising:
means for assigning a sequence identifier to each of the packets that specifies a serial order associated with the packet;
means for providing the packets to the plurality of parallel processors;
means for processing the packets in parallel using the plurality of parallel processors; and
means for ordering the processed packets at an output of the one of the plurality of transform modules based on the sequence identifiers assigned to the packets.

41. The system of claim 39, wherein the packets comprise a first plurality of packets associated with an inbound packet stream and a second plurality of packets associated with an outbound packet stream.

42. The system of claim 41, wherein the means for processing the encapsulated packets comprises means for processing the first plurality of packets associated with the inbound packet stream and the second plurality of packets associated with the outbound packet stream using at least one of the plurality of transform modules.

43. The system of claim 39, further comprising:
means for updating routing flags in a respective one of the packet-object headers to indicate whether a respective one of the packet-objects should be processed by the plurality of transform modules, passed through the plurality of transform modules without being transformed, or captured by a system processor.

44. The system of claim 43, further comprising:
means for capturing a respective one of the encapsulated packets to a system processor based on at least one of the routing flags.

45. The system of claim 39, further comprising:
means for multiplexing an inbound stream of encapsulated packets with an outbound stream of encapsulated packets into a serial stream of encapsulated packets.

46. The system of claim 45, further comprising:
means for verifyng that a respective one of the encapsulated packets has fields that are populated with data that are within specified limits.

47. The system of claim 45, further comprising:
means for extracting selectors from a respective one of the outbound encapsulated packets; and
means for obtaining a security policy index from a security policy database for the respective one of the outbound encapsulated packets based on the extracted selectors.

48. The system of claim 47, wherein the selectors comprise a source IP address, a destination IP address, a protocol, a source port, and a destination port.

49. The system of claim 48, wherein the protocol is a transport protocol.

50. The system of claim 47, further comprising:
means for searching a security association database to obtain a security association for the respective one of the outbound encapsulated packets based on the extracted selectors and the security policy index.

51. The system of claim 50, wherein the means for searching the security association database comprises:
means for hashing the extracted selectors and the security policy index to obtain a hash key value; and
means for performing a linear search in the security association database using the hash key value.

52. The system of claim 50, further comprising:
means for inserting cryptographic information into the packet-object header of the respective one of the outbound encapsulated packets based on the security association for the respective one of the outbound encapsulated packets.

53. The system of claim 41, further comprising:
means for extracting selectors from a respective one of the inbound encapsulated packets.

54. The system of claim 53, wherein the selectors comprise a destination IP address, a protocol, a security policy index, and an interface port.

55. The system of claim 54, wherein the protocol is a transport protocol.

56. The system of claim 53, further comprising:
means for searching a security association database to obtain a security association for the respective one of the inbound encapsulated packets based on the extracted selectors.

57. The system of claim 56, wherein the means for searching the security association database comprises:
means for hashing the extracted selectors to obtain a hash key value; and
means for performing a linear search in the security association database using the hash key value.

58. The system of claim 56, further comprising:
means for inserting cryptographic information into the packet-object header of the respective one of the inbound encapsulated packets based on the security association for the respective one of the inbound encapsulated packets.

59. The system of claim 41, further comprising:
means for decrypting a respective one of the inbound encapsulated packets; and
means for verifying that the respective one of the inbound encapsulated packets has fields that are populated with data that are within specified limits.

60. The system of claim 41, further comprising:
means for fragmenting a respective one of the encapsulated packets if a size of the respective one of the encapsulated packets exceeds a maximum transmission unit size associated with the respective one of the encapsulated packets.

61. The system of claim 41, further comprising:
means for decrypting a respective one of the inbound encapsulated packets;
means for extracting selectors from the respective one of the inbound encapsulated packets; and
means for obtaining a security policy index from a security policy database for the respective one of the inbound encapsulated packets based on the extracted selectors.

62. The system of claim 61, wherein the selectors comprise a source IP address, a destination IP address, a protocol, a source port, a destination port, and an interface port.

63. The system of claim 62, wherein the protocol is a transport protocol.

64. A computer program product for processing packets, comprising:
a computer readable program medium having computer readable program code embodied therein, the computer readable program code comprising:
computer readable program code configured to receive the packets;
computer readable program code configured to encapsulate each of the packets that does not have a packet-object header with a packet-object header; and
computer readable program code configured to process the encapsulated packets based on information contained in the packet-object headers using a plurality of transform modules that are coupled to each other in a series configuration, respective ones of the plurality of transform modules processing the encapsulated packets in parallel independent of other ones of the plurality of transform modules.

65. The computer program product of claim 64, further comprising:
computer readable program code configured to update routing flags in a respective one of the packet-object headers to indicate whether a respective one of the packet-objects should be processed by the plurality of transform modules, passed through the plurality of transform modules without being transformed, or captured by a system processor.

66. The computer program product of claim 65, further comprising:
computer readable program code configured to capture a respective one of the encapsulated packets to a system processor based on at least one of the routing flags.

67. The computer program product of claim 64, further comprising:
computer readable program code configured to multiplex an inbound stream of encapsulated packets with an outbound stream of encapsulated packets into a serial stream of encapsulated packets.

68. The computer program product of claim 67, further comprising:
computer readable program code configured to verify that a respective one of the encapsulated packets has fields that are populated with data that are within specified limits.

69. The computer program product of claim 67, further comprising:
computer readable program code configured to extract selectors from a respective one of the outbound encapsulated packets; and
computer readable program code configured to obtain a security policy index from a security policy database for the respective one of the outbound encapsulated packets based on the extracted selectors.

70. The computer program product of claim 69, wherein the selectors comprise a source IP address, a destination IP address, a protocol, a source port, and a destination port.

71. The computer program product of claim 70, wherein the protocol is a transport protocol.

72. The computer program product of claim 69, further comprising:
computer readable program code configured to search a security association database to obtain a security association for the respective one of the outbound encapsulated packets based on the extracted selectors and the security policy index.

73. The computer program product of claim 72, wherein the computer readable program code configured to search the security association database comprises:
computer readable program code configured to hash the extracted selectors and the security policy index to obtain a hash key value; and
computer readable program code configured to perform a linear search in the security association database using the hash key value.

74. The computer program product of claim 72, further comprising:
computer readable program code configured to insert cryptographic information into the packet-object header of the respective one of the outbound encapsulated packets based on the security association for the respective one of the outbound encapsulated packets.

75. The computer program product of claim 67, further comprising:
computer readable program code configured to extract selectors from a respective one of the inbound encapsulated packets.

76. The computer program product of claim 75, wherein the selectors comprise a destination IP address, a protocol, a security policy index, and an interface port.

77. The computer program product of claim 76, wherein the protocol is a transport protocol.

78. The computer program product of claim 75, further comprising:
computer readable program code configured to search a security association database to obtain a security association for the respective one of the inbound encapsulated packets based on the extracted selectors.

79. The computer program product of claim 78, wherein computer readable program code configured to search the security association database comprises:
computer readable program code configured to hash the extracted selectors to obtain a hash key value; and
computer readable program code configured to perform a linear search in the security association database using the hash key value.

80. The computer program product of claim 78, further comprising:
computer readable program code configured to insert cryptographic information into the packet-object header of the respective one of the inbound encapsulated packets based on the security association for the respective one of the inbound encapsulated packets.

81. The computer program product of claim 67, further comprising:
computer readable program code configured to decrypt a respective one of the inbound encapsulated packets; and
computer readable program code configured to verify that the respective one of the inbound encapsulated packets has fields that are populated with data that are within specified limits.

82. The computer program product of claim 67, further comprising:
computer readable program code configured to fragment a respective one of the encapsulated packets if a size of the respective one of the encapsulated packets exceeds a maximum transmission unit size associated with the respective one of the encapsulated packets.

83. The computer program product of claim 67, further comprising:
computer readable program code configured to decrypt a respective one of the inbound encapsulated packets;
computer readable program code configured to extract selectors from the respective one of the inbound encapsulated packets; and
computer readable program code configured to obtain a security policy index from a security policy database for the respective one of the inbound encapsulated packets based on the extracted selectors.

84. The computer program product of claim 83, wherein the selectors comprise a source IP address, a destination IP address, a protocol, a source port, a destination port, and an interface port.

85. The computer program product of claim 84, wherein the protocol is a transport protocol.
